(19) United States
(12) Patent Application Publication
(10) Pub. No.: US 2025/0198226 A1
(43) Pub. Date: Jun. 19, 2025

(54) MODULAR STACKED TRANSOM AND DOOR SUPPORT

(71) Applicant: DIRTT ENVIRONMENTAL SOLUTIONS LTD., Calgary (CA)

(72) Inventors: Adam J. Stosky, Calgary (CA); Thomas A. Brown, Calgary (CA); Spencer D. Haddow, Calgary (CA)

(21) Appl. No.: 19/052,246

(22) Filed: Feb. 12, 2025

Related U.S. Application Data
(60) Provisional application No. 63/611,625, filed on Dec. 18, 2023.

(51) Int. Cl. E06B 1/36; E05D 15/06

(52) U.S. Cl. CPC E06B 1/366; E05D 15/0617; E05Y 2201/684; E05Y 2201/688

(57) ABSTRACT

A modular door frame having a base transom horizontal and a plurality of vertical frame members. The modular door frame can further include a secondary transom. The secondary transom can be a sliding door track that is superimposed over the base transom horizontal. In the implementation of the modular door frame, base transom horizontal can be a stopper transom horizontal configured for a hinged door and can include a stopper. The secondary transom is superimposed over the base transom horizontal to avoid occluding portions of the door (below) and a clerestory (above). The clerestory and door may be glass. The secondary transom is secured to the base transom horizontal by inserting a hook on the secondary transom into a channel in the base transom horizontal. The connection is a secure, cantilevered connection that does not require tools or fasteners.

### CROSS-REFERENCE TO RELATED APPLICATIONS

This application claims the benefit of priority to U.S. Provisional Application No. 63/611,625, filed on Dec. 18, 2023, the entire disclosure of which is incorporated herein by reference.

### BACKGROUND

### 1. Background and Relevant Art

Conventional modular walls and doors provide flexibility in the design of a room or a space. Some modular walls and doors include prominent panes of glass or similar aesthetic materials. However, supporting and partitioning the glass panels used in these conventional modular walls and doors can present challenges as glass panels are heavier than counterparts made of other materials. Thus, providing structural supports that accommodate glass panels while also being able to use glass panels in varied locations along a conventional modular wall or door has been a sustained challenge. Additionally, when walls are quite tall, it is sometimes advantageous to use doors that are not full height, and this can present challenges with conventional modular doors and walls. Accordingly, there are a number of difficulties in conventional systems that can be addressed.

### BRIEF SUMMARY

The present disclosure is directed to a modular door frame that includes frame members that are elongated channels that can be installed into an existing building. The frame includes vertical frame members and a base transom horizontal extending horizontally between the vertical frame members. In one embodiment for hinged doors the base transom horizontal has an upper groove, and a front face. The modular door frame also includes a clerestory panel above the base transom in the upper groove. There is also a stacked transom horizontal extending horizontally and being generally aligned with the base transom horizontal. The stacked transom horizontal is superimposed over the base transom horizontal and does not occlude the door below or the clerestory panel above. The modular door frame also includes an attachment feature coupling the stacked transom to the lower verticals, and a door hanging from those verticals.

Further embodiments of the present disclosure for hinged doors are directed to a modular door frame having two first vertical members comprising elongated channels oriented vertically and extending from a floor to a top of door height, two second vertical members comprising elongated channels oriented vertically and positioned over the two first vertical members, and a stopper transom horizontal coupled to the first and second vertical members. The stopper transom horizontal is an elongated channel, similar to the base transom horizontals of the present disclosure, having an upper groove on an upper face and further including a door stop extending downwardly from the stopper transom horizontal to provide a surface for scaling to prevent sound transmission and airflow. The modular door frame also includes an upper frame member comprising an elongated channel substantially equal in length to the stopper transom horizontal and having a lower groove, and a clerestory held within the upper groove of the stopper transom horizontal and the lower groove of the upper frame and being held between the two second vertical members. The modular door frame can carry a swinging door hingedly coupled to one of the first vertical frame members and that closes against a stopper transom horizontal. The swinging door is aligned with the stopper transom horizontal and being stopped by the door stop.

Further embodiments of the present disclosure for sliding doors are directed to a modular door frame including two vertical frame members and a base transom horizontal extending between the two vertical frame members. The base transom horizontal has a channel at an upper, front edge. The modular door frame also accommodates a sliding door track positioned in front of the base transom, and a hook rigidly fastened to the sliding door track, the hook having a tongue that fits within the channel on the base transom horizontal.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific implementations thereof which are illustrated in the appended drawings. Understanding that these drawings depict only typical implementations of the invention and are not therefore to be considered to be limiting of its scope, the invention will be described and explained with additional specificity and detail through the use of the accompanying drawings in which:

FIG. 1 is an isometric view of a modular wall with a hinged door according to embodiments of the present disclosure;

FIG. 2 is a partial side cross-sectional view of a modular sliding door and transom according to the present disclosure;

FIG. 3 is an exploded view of a modular hinged door with transom according to embodiments of the present disclosure;

FIG. 4 is a cross-sectional view of a base transom horizontal and a sliding door track according to embodiments of the present disclosure;

FIG. 5 is a cross-sectional view of a stopper transom for use with the modular wall components and hinged doors according to the present disclosure; and

FIG. 6 is a schematic front view of a modular door frame according to embodiments of the present disclosure.

### DETAILED DESCRIPTION

The present disclosure is directed to a modular door or wall having a glass panel and structural members that provide adequate structure, strength, and resilience in an aesthetically pleasing manner. The present disclosure refers to walls and doors, which are, in some circumstances, interchangeable except for certain aspects discussed herein. For purposes of brevity and conciseness, reference is made herein to doors and walls interchangeably without loss of generality and without limiting the scope of the present disclosure.

The modular doors and walls of the present disclosure include a frame defining a door opening. The frame includes vertical frame members at either side of the door opening and a base transom horizontal defining the top of the door opening. The base transom horizontal extends horizontally across the width of the door opening. The base transom horizontal may be made using an extrusion process to create a generally uniform cross-sectional shape. The base transom horizontal can include attachment features that are described in greater detail below that facilitate connection with other components of the present disclosure.

The modular door also includes a clerestory disposed above the base transom horizontal. The clerestory is a glass panel above the door opening that provides a pleasing aesthetic feature that allows light and vision to pass over the modular door. The clerestory includes frame members, including vertical frame members, and an upper frame disposed on the opposite side of the clerestory relative to the base transom horizontal. The upper frame spans between two vertical frame members. The clerestory can be substantially the same width as the door opening and the base transom horizontal. The width of the walls, doors, transom horizontals, and clerestories of the present disclosure may vary to fit within structures that vary in size.

The modular door can include a stacked transom horizontal (also referred to as a sliding door track herein) that couples to the base transom horizontal and is substantially the same size as the base transom horizontal such that the stacked transom horizontal does not occlude the door opening. In some embodiments, the stacked transom horizontal is smaller in height than the base transom horizontal. The base transom horizontal and stacked transom horizontal can each include complementary attachment features that interlock to secure the stacked transom horizontal to the base transom horizontal. The stacked transom horizontal and base transom horizontal can support a door or wall that hangs below the stacked transom horizontal, with the door adjacent to and near the main panel or the rest of a modular wall.

The door can be a sliding door that moves along a track supported by the stacked transom horizontal. The door can, therefore, be configured to slide laterally to open and close the sliding door. In some implementations of the present disclosure, the door can also be a swinging door, in which case the base transom horizontal or stack transom can include a stopper to prevent the door from moving beyond a closed position and to prevent sound, light, and air gaps. In some embodiments, there is no door stop, and the door is permitted to swing open in both directions.

The frame components, including the base transom horizontal, the vertical frame members, the upper frame, and the stacked transom horizontal can be fastened together using screws that penetrate the metal structure of the frame components to hold the frame members to the glass panels such as the clerestory main panel and the modular door itself, each of which can be large flat glass panels or other materials.

In some embodiments, the attachment features of the base transom horizontal or stacked transom horizontal include a channel formed in the extruded shape that runs the length of the base transom horizontal. A hook can be attached to a stacked transom horizontal or sliding door track, and the hook fits within the channel to hold the sliding door track against the base transom horizontal with sufficient strength to support the door.

The sliding door track can include an interior shape that receives a roller connected to the sliding door that permits the door to roll along the track to open and close the door. The stacked transom horizontal, otherwise known as a sliding door track, can extend beyond the sides of the door opening to support the sliding door when it is in an open position. In some embodiments, the door can be a sliding stacked door with two portions—left and right-forming a double door pair. The left side can slide to the left and the right side can slide to the right. The sliding door track can be two separate sliding door tracks, one left and one right, or a single sliding door track can accommodate both the left door and the right door. In at least one embodiment, the base transom horizontal, stacked transom horizontal, or sliding door frame can be configured to receive two or more panels or panes of glass. In such an embodiment, a gap can be present between the panels or panes, and the thickness of the gap is defined by the distance between the slots configured to receive the panels or panes.

Because sliding door tracks span across a wall next to the door to support the door in the open position it may also be beneficial that glass walls beside door openings be able to receive the same sliding door track or a similar sliding door track and support the weight of the door and track. The base transom horizontal can accordingly also be used in wall frames between an upper and a lower glass pane.

In other embodiments, the present disclosure is directed to a modular door, including a stopper transom horizontal with an integrated door stop that extends below the stopper transom horizontal to stop a door in a closed position. The stopper transom horizontal is an elongated channel member with a generally square cross-sectional shape, similar to that of a base transom horizontal of the present disclosure. The stopper transom horizontal is hollow, but an assembler or builder may fill the interior space with an insulating material to deaden sound transfer and mitigate heat transfer, i.e., denim insulation. The top of the stopper transom horizontal may include a groove that carries a clerestory panel above the stopper transom horizontal. The stopper transom horizontal may also engage with vertical frame members that define a door area, and with vertical frame members that define a clerestory area. In some embodiments, the stopper transom horizontal includes interior features that receive splines passing through to fasten the stopper transom horizontal to the vertical frame members. The same splines or similar splines can also pass through a plurality of vertical frame members to fasten and secure them together. In some embodiments, the interior features include two upper spline-receiving features and two lower spline-receiving features, and the assembler fastens the vertical clerestory frame members to the upper spline-receiving features and the vertical door frame members to the lower spline-receiving members.

The door stop can protrude downward from a rear portion of the stopper transom horizontal such that the door positioned below that is narrower than the stopper transom horizontal can contact the door stop and maintain its position in alignment with the stopper transom horizontal above. The door stop may extend along the entire length of the stopper transom horizontal, or in other embodiments, the stopper is positioned only at certain locations, such as near the swinging end of the door.

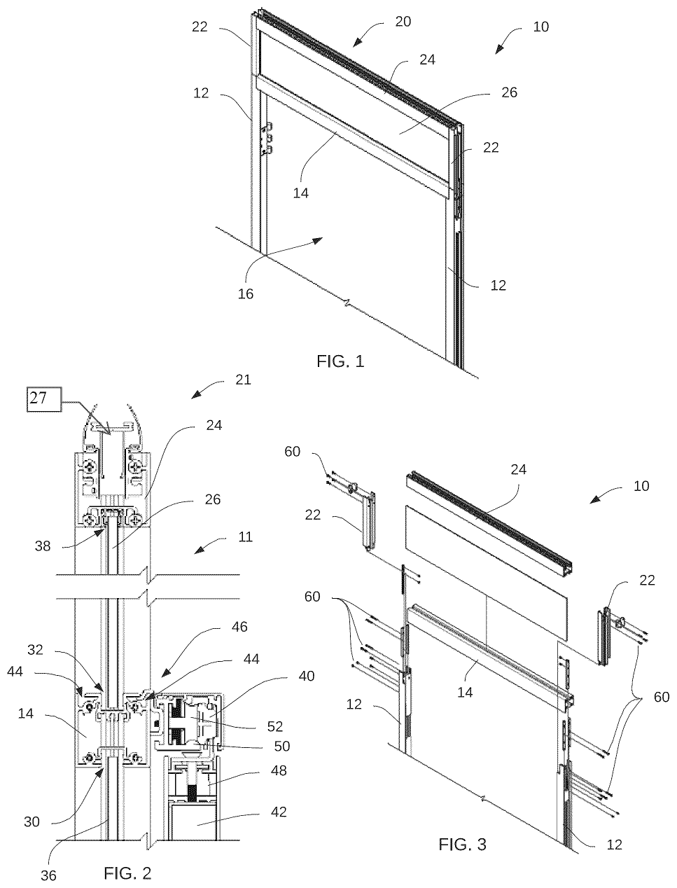

FIG. 1 is an isometric view of a modular door frame 10 according to the embodiments of the present disclosure. The modular door frame 10 includes vertical frame members 12 and a base transom horizontal 14 that extends between the vertical frame members 12 defining a door opening 16. The modular door frame 10 also includes a clerestory 20 positioned over the door opening 16. Clerestory 20 includes vertical side clerestory members 22, an upper frame horizontal 24, and a clerestory panel 26. In some embodiments the vertical frame members 12 and the vertical side clerestory members 22 are a single vertical frame member. For example, the leftmost vertical frame member 12 and the leftmost vertical frame member 22 of FIG. 1 can be a single vertical frame member rather than two distinct elements as illustrated, and the same can be true regarding the right-most vertical frame members 12 and 22. In yet another embodiment, a spline or plurality of splines can be secured on the interior of the leftmost vertical frame member 12 and the leftmost vertical frame member 22 of FIG. 1 to form one singular vertical frame member.

The frame members defining the modular door frame 10 and clerestory 20 can be made of an extruded material such as aluminum, plastic, steel, or another suitable material. The frame members can have a uniform cross-sectional shape and a generally uniform thickness to provide a consistent appearance and a flat exterior surface. Additionally, the frame members can be secured together with a plurality of various fasteners and bracketing/splines and can further include indexing grooves or elements that enable connectivity and additional rigidity.

FIG. 2 is a partial side cross-sectional view of a modular sliding door frame 11 and a clerestory 21, according to the present disclosure. The cross-section of the view intersects the door and glass wall next to the door opening, with the door in the open position. The cross-section also intersects the frame members, including the base transom horizontal 14, the upper frame horizontal 24, a sliding door track 40 (also referred to as a stacked transom horizontal herein), and a sliding door 42. As shown in FIG. 2, the frame members are elongated structures with generally uniform cross-sections due to the extrusion procedure used in their construction.

FIG. 2 shows that the base transom horizontal 14 can include a lower groove 30 disposed along its lower surface that can receive a glass panel 36 and retain it in a set position below the base transom horizontal 14. The glass panel 36 below the base transom horizontal 14 may occupy part of the glass wall beside the door opening 16. In some embodiments, the glass panel 36 below the base transom horizontal 14 can occupy the opposing sides of the door opening 16. The base transom horizontal 14 also includes an upper groove 32 along the top surface that receives the clerestory panel 26 and retains it in a set position above base transom horizontal 14. The lower groove 30 and upper groove 32 can be centrally located in the base transom horizontal 14 and can be deep enough to provide sufficient support to the edges of the glass panels they support. A filler (not shown) can be inserted into the lower groove 30 when a panel is not installed to allow for the bottom of the base transom horizontal 14 to define the upper end of the door opening.

FIG. 2 shows that the upper frame horizontal 24 can include a lower groove 38 that receives an upper end of the clerestory panel 26, similar to how the upper groove 32 in the base transom horizontal 14 receives the bottom end of the clerestory panel 26. The upper frame horizontal 24 can also include modular coupling features 27 disposed along the top side of the upper frame horizontal 24 that can secure to the ceiling or similarly elevated surface of the structure into which the modular sliding door frame 11 is installed. Modular coupling features 27 can be structural, functional, and/or aesthetic in nature. Modular coupling features 27 can be structural by supporting the upper frame horizontally 24 by way of a rigid connection. Modular coupling features 27 can be functional by providing acoustic, light, or sound dampening. Modular coupling feature 27 can be aesthetic by providing a visual surface or transition between a ceiling and the frame of the present disclosure.

FIG. 2 shows that the base transom horizontal 14 can also includes two channels 44 running along its length wherein one channel 44 is positioned along one top edge while the second channel 44 is positioned along the opposing top edge. Channels 44 are oriented vertically along the length of the base transom horizontal 14. Channels 44 are constructed as part of the base transom horizontal 14 and are configured to support a sliding door track 40, which supports a sliding door 42 hanging from the sliding door track 40. The sliding door track 40 is positioned in front of or behind the base transom horizontal 14. Additionally, sliding door track 40 can have the same or a smaller vertical dimension such that the sliding door track 40 does not occlude any of the glass panel 36 below or the clerestory panel 26 above. The sliding door track 40 includes attachment features 46 that engage with a channel 44, specifically the inner surfaces of channel 44, and provide the structural supporting connection between the sliding door track 40 and the base transom horizontal 14. Attachment features 46 enable sliding door track 40 to hang from channel 44 while also resting against the side of base transom horizontal 14. Sliding door track 40 can be a singular extruded member or a plurality of members. In an embodiment where the sliding door track 40 is a plurality of members, it can comprise a cover that is selectively coupled to the sliding door track. In at least one embodiment, fasteners are not needed as each member has connection means that are configured to clip, clamp, or otherwise interlock together.

FIG. 2 shows that the sliding door 42 ca include a door frame member 48 that engages with the sliding door track 40. In the shown embodiment, sliding door track 40 includes a ridge 50 that receives a roller 52 wherein the roller has a concave complementary profile to the convex profile of ridge 50. The roller is attached to the sliding door 42, and the roller 52, ridge 50, and door frame member 48 enable the sliding door 42 to move from side-to-side relative to base transom horizontal 14 slidably and to open and close sliding door 42. A plurality of rollers 52 can be utilized to provide a user with a smooth and low-effort sliding experience of sliding door 42. In some embodiments, roller 52 can include an internal bearing or be connected to a bearing. The roller 52 is connected to a series of brackets, members, and fasteners that allow roller 52 to support sliding door 42. The sliding door 42 can also be a swinging door.

FIG. 3 is an exploded view of a modular door frame 10 according to the embodiments of the present disclosure. The upper frame horizontal 24, the vertical side clerestory members 22, the stopper transom horizontal 100 (similar to base transom horizontal 14), and vertical frame members 12 may be fastened together using screws 60 that penetrate and secure the frame members together. Further, indexing grooves or elements can be seen between the connection points of the frame members. Indexing grooves or elements and splines aid in the securing of frame members together.

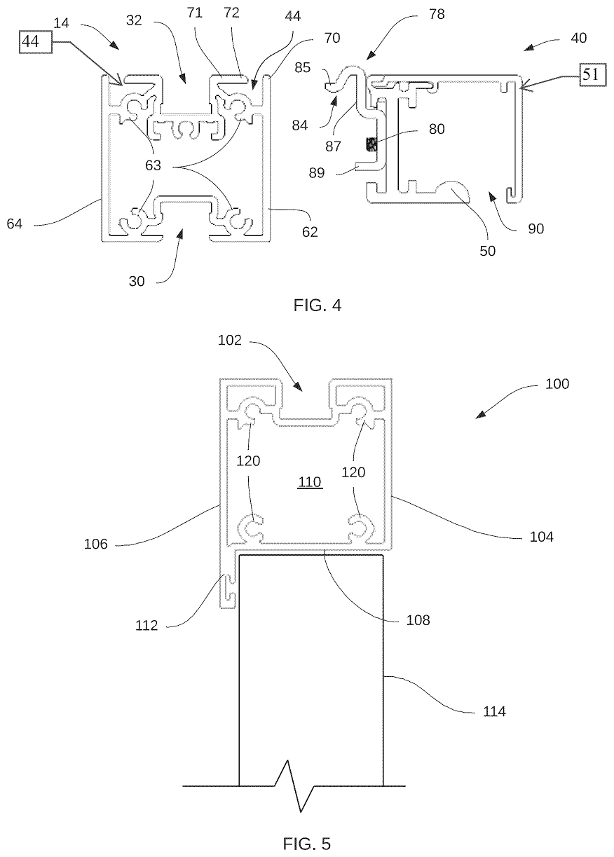

FIG. 4 is a cross-sectional view of a base transom horizontal 14 and a sliding door track 40 (also referred to as a stacking transom herein) according to the embodiments of the present disclosure. The base transom horizontal 14 is an elongated, extruded member having a generally square cross-sectional shape. A top region of the base transom horizontal 14 includes the upper groove 32 that carries the clerestory panel 26 above. A bottom region of the base transom horizontal 14 has the lower groove 30 that accommodates a panel below, if any. At a right-hand side of the base transom horizontal 14 is a front face 62 that is a generally flat surface that is strengthened by interior features 63 of the base transom horizontal 14. The interior features 63 provide strength and serve as connection points or indexing elements to other adjacent features or members to which the base transom horizontal 14 is to be secured. For example, the interior features 63 can be secured to other frame members of the modular door 10, to an existing wall (modular or conventional), or to the door jamb of the existing structure in which the modular door 10 is to be installed. Interior features 63 can also be configured to receive clips or connecting features or means of an end cap or aesthetic cover to secure it to the frame members.

In some embodiments, the interior of the base transom horizontal 14 can be filled with insulative materials, such as denim insulation, to reduce sound transmission and mitigate airflow for thermal insulation purposes.

Shown in FIG. 4, opposite the front face 62 can be a rear face 64, which is substantially similar to the front face 62. In some embodiments, the base transom horizontal 14 is symmetrical about its vertical plane and can accommodate a sliding door track on its back side using the rear face 64 as well. A sliding door track would secure into channel 44 adjacent to the rear face 64.

FIG. 4 shows that the base transom horizontal 14 can include channels 44 one of which is formed between the upper-most surface and the front face 62 of base transom horizontal 14. The second is formed similarly to the first but is between the upper-most surfaces and the rear face 64. The front face 62 terminates at its upper extent with a front channel edge 70 that is as high as the upper-most surface 71 of the base transom horizontal 14. The upper-most surface 71 is a horizontally disposed surface that extends toward, but does not connect to, the front channel edge 70 and instead terminates in a top channel edge 72. The front channel edge 70 and the top channel edge 72 define an opening to the channel 44. The interior components 63 can also define portions of channel 44 and provide strength and support for the perimeter of channel 44. As illustrated in FIG. 4, the left-most channel 44 can comprise similar elements.

FIG. 4 shows that the sliding door track 40 can be secured to the base transom horizontal 14 using an attachment feature, previously shown as attachment feature 46. In the depicted embodiment, the attachment feature is a hook 78 that is secured to the sliding door track 40 and is inserted into channel 44 to support and stabilize the sliding door track 40. Hook 78 is secured to the sliding door track 40 with a fastener 80 that passes through a portion of hook 78 and a portion of the sliding door track 40 to rigidly secure hook 78 to the sliding door track 40. The hook 78 includes a tongue 84 that extends outwardly and upwardly and complements the shape of channel 44 and its interior components 63.

An assembler can fasten hook 78 to the sliding door track 40 with the fastener 80 and can then raise and angle the sliding door track 40 and hook 78 and insert the tongue 84 of hook 78 into channel 44. The complementary shapes of the tongue 84, hook 78, and channel 44 provide stability for the sliding door track 40 and the sliding door 42 that hangs from the sliding door track 40. As such, the fit between tongue 84 and channel 44 is a cantilever fit, and the weight of the sliding floor track 40 and sliding door 42 assist in maintaining a secure connection. The tongue 84 includes a first contact region 85 that is generally flat and horizontal and, when inserted into channel 44, contacts the top channel edge 72 on an interior, downward-facing surface, forming the cantilever fit. The tongue 84 also includes a second contact region 87 that contacts the front face 62 of the base transom horizontal 14 as well as a protrusion 89 that also contacts the front face 62 of the base transom horizontal 14 and maintains alignment of sliding door track 40 and the base transom horizontal 14. The protrusion 89 provides stabilizing support to sliding door track 40 against base transom horizontal 14. Hook 78 enables the sliding door track 40 to be installed to and supported by the base transom horizontal 14 without the use of additional fasteners or tools. FIG. 2 shows the sliding door track 40 coupled to the base transom horizontal 14 with the hook within channel 44.

In some embodiments, hook 78 is capable of sliding along channel 44 without impediment such that the sliding door track 40 can be positioned along the base transom horizontal 14 at any desired location. In such an embodiment, a plurality of hooks 78 can be secured to sliding door track 40 along its length at varied intervals. In at least one embodiment, hook 78 is elongated, and only one hook 78 is used to secure the sliding door track to base transom horizontal 14. In such an embodiment, hook 78 can extend for a substantial length, similar to the length of the sliding door track it is secured to, and a plurality of screws can secure hook 78 to the sliding door track. In another embodiment, channel 44 and hook 78 are not elongated and continuous; rather, they are positioned at specific locations along their length to ensure that the sliding door track 40 is located and secured in a desired location. In such an embodiment, a plurality of channels 44 and hooks 78 can be present.

FIG. 4 shows that the sliding door track 40 can include a ridge 50 that engages with a roller (see FIG. 2), enabling the modular door 10 to be a sliding door. The sliding door track 40 also includes an opening 90 through which the door frame member 48 can be placed. As previously described, sliding door track 40 can be formed from a plurality of parts. As illustrated here, cover 51 can be selectively coupled with sliding door track 40 to allow for an assembler to install the rollers 52. In such a case, an assembler would install the sliding door track 40 onto base transom horizontal 14 as previously described. The assembler can then decouple the cover 51 to more fully reveal ridge 50. The assembler can then align rollers 52 onto ridge 50 and then couples cover 51 back onto sliding door track 40. This process allows sliding door track 40 to maintain an aesthetic visual surface while also allowing easy access to its internal elements.

FIG. 5 is a cross-sectional view of an embodiment of stopper transom horizontal 100, a variation of base transom horizontal 14, for use with the modular wall components according to the present disclosure. Stopper transom horizontal 100 is an elongated, extruded channel having a generally square cross-sectional shape. It has an upper groove 102 that can receive and support a clerestory panel (not shown) in the upper groove 102 that extends upward from the upper groove 102. There is a front face 104 that is a generally flat surface that is visible and therefore can have an aesthetically pleasing finish. Opposite the front face 104 is a rear face 106. A bottom face 108 joins the front face 104 to the rear face 106. The interior space 110 of the base transom horizontal 14 can be empty or filled with insulation to inhibit transmission of sound and temperature transmission.

FIG. 5 shows that the stopper transom horizontal 100 can include a door stop 112 that protrudes from the rear face 106 and downward away from bottom face 108. The door stop 112 is flush with rear face 106 and maintains/extends the rear face 106 downward. The door stop 112 provides a physical limit to the swing of a door 114 which is positioned below the base transom horizontal 14. Door stop 112 is configured to receive at least a portion of a stopper material such as rubber to provide a soft contact surface which abuts door 114 when closed. The door 114 can be hung below the base transom horizontal 14 along a vertical frame member 12 using a hinged connection. The door 114 can, therefore, rest directly below the stopper transom horizontal 100 and clerestory above when in the closed configuration.

The stopper transom horizontal 100 includes interior features 120 that facilitate connection with other frame members. To assemble the frame members, an assembler can insert splines or brackets (not shown) into the interior features to fasten the frame members together.

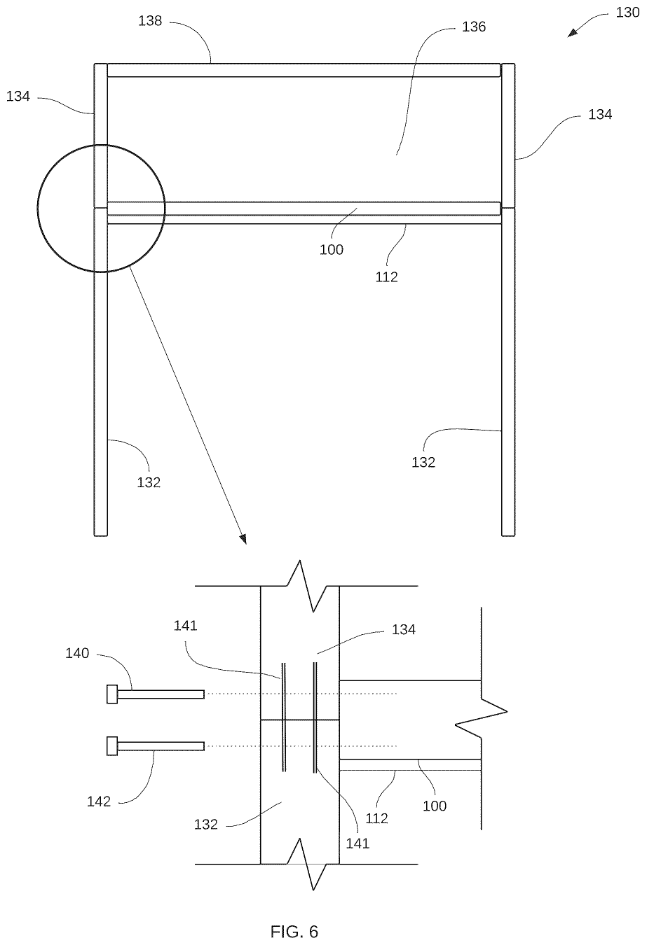

FIG. 6 is a schematic front view of a modular door frame 130 according to the embodiments of the present disclosure. The modular door frame 130 includes first vertical members 132 that extend from the floor to the height of a modular door that will be hung from the modular door frame 130, or to the height at which a clerestory 136 will be secured. The modular door frame 130 also includes second vertical members 134, which are placed and secured above the first verticals 132 and extend upward to support a clerestory 136 that will be held above the door. The clerestory 136 can be a glass panel similar to other clerestories shown and described herein.

FIG. 6 shows the modular door frame 130 also can include a stopper transom horizontal 100 spanning the width of the door opening between the first vertical members 132 and second vertical members 134. The stopper transom horizontal 100 includes a door stop 112 visible below. There is also an upper frame member 138 that provides upper support for the clerestory 136 and can interface with or couple to a ceiling of the structure in which the modular door frame 130 is installed.

FIG. 6 also shows a magnified detailed section showing how a portion of the modular door frame is connected. The stopper transom horizontal 100 is joined to the first vertical member 134 by inserting a first fastener 140 through the first vertical member 134 and is threaded into an interior feature (see FIG. 4) within the stopper transom horizontal 100. A second fastener 142 is similarly inserted through the second vertical member 132 and threaded into an interior feature of the stopper transom horizontal 100. Bar splines 141 can also be used as a bracket element between two or more frame members to provide a more secure connection. The modular door frame structure is strong, resilient, and easy to install and provides support for a clerestory 136 above the door. The modular design allows for installation in an existing structure at a minimal cost.

In some embodiments the stopper transom horizontal 100 can instead be a base transom horizontal similar to that shown and described with respect to FIGS. 1-3. A stacked transom horizontal or sliding door track can be used with the base transom horizontal in conjunction with the modular door frame 130, according to the present disclosure.

The present invention may be embodied in other specific forms without departing from its spirit or essential characteristics. Aspects of the present disclosure described and shown with respect to a door can apply equally to walls and wall panels. The described implementations are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. A modular door frame comprising:
vertical frame members comprising elongated channels;
a base transom horizontal comprising an elongated channel extending horizontally between the vertical frame members, the base transom horizontal comprising an upper groove and a front face;
a clerestory panel above the base transom horizontal in the upper groove;
a sliding door track comprising an elongated channel extending horizontally and being generally aligned with the base transom horizontal;
an attachment feature coupling the sliding door track to the base transom horizontal; and
a door hanging from the sliding door track.

2. The modular door frame of claim 1 wherein the sliding door track comprises a cover that is selectively couplable without fasteners.

3. The modular door frame of claim 1 wherein the base transom horizontal comprises a channel, and wherein the attachment feature comprises a hook that fits within the channel.

4. The modular door frame of claim 3 wherein the hook and channel form a cantilever fit that holds the sliding door track in place relative to the base transom horizontal without using fasteners.

5. The modular door frame of claim 1 wherein the sliding door track comprises a ridge on an interior surface, wherein the door comprises a roller that fits within the sliding door track and engages with the roller and is configured to slidably move relative to the base transom horizontal.

6. The modular door frame of claim 1, wherein the base transom horizontal further comprises a lower groove configured to receive a panel.

7. The modular door frame of claim 1, further comprising:
vertical side clerestory members that are generally aligned with the vertical frame members and extend vertically above the vertical frame members; and
an upper frame attached to the vertical side clerestory members, wherein the upper frame comprises a groove that receives an upper edge of the clerestory panel, and wherein the vertical side clerestory members are fastened to the upper frame and to the base transom horizontal.

8. The modular door frame of claim 1 wherein the base transom horizontal further comprises interior features configured to strengthen the base transom horizontal and to receive connection features or means.

9. A modular door frame, comprising:
two first vertical members comprising elongated channels oriented vertically and extending from a floor to a door height;
two second vertical members comprising elongated channels oriented vertically and positioned over the two first vertical members;
a stopper transom horizontal coupled to the first and second vertical members, the stopper transom horizontal comprising an elongated channel comprising an upper groove on an upper face of the stopper transom horizontal and a door stop extending downwardly from the stopper transom horizontal;
an upper frame member comprising an elongated channel substantially equal in length to the stopper transom horizontal and comprising a lower groove;
a clerestory held within the upper groove of the stopper transom horizontal and the lower groove of the upper frame and being held between the two second vertical members; and
a swinging door hingedly coupled to one of the first vertical members below the stopper transom, the swinging door being substantially aligned with the stopper transom horizontal and being stopped by the door stop.

10. The modular door frame of claim 9 wherein the stopper transom horizontal comprises interior features that receive fasteners, the modular door frame further comprising:
first fasteners passing through the first vertical members and engaging with the interior features of the stopper transom horizontal, and
second fasteners passing through the second vertical members and engaging with the interior features of the stopper transom horizontal.

11. The modular door frame of claim 9 wherein the upper frame further comprises interior features and the modular door frame further comprises splines passing through the second vertical members and being engaged with the interior features of the upper frame.

12. The modular door frame of claim 9 wherein the door stop extends along an entire length the stopper transom horizontal.

13. A modular door frame, comprising:
two vertical frame members;
a base transom horizontal comprising an elongated channel extending between the two vertical frame members, the base transom horizontal comprising a channel at an upper, front edge of the base transom horizontal;
a sliding door track positioned in front of the base transom horizontal; and
a hook rigidly fastened to the sliding door track, the hook comprising a tongue that fits within the channel on the base transom horizontal.

14. The modular door frame of claim 13 wherein the base transom horizontal comprises an upper groove, the modular door frame further comprises a clerestory panel above the base transom horizontal and held within the upper groove of the base transom horizontal.

15. The modular door frame of claim 14, further comprising:
two vertical clerestory frame members aligned with and coupled to the two vertical frame members; and
an upper frame spanning between the two vertical clerestory frame members, wherein the upper frame and two vertical clerestory frame members support the clerestory panel, and wherein the two vertical clerestory frame members are coupled to the base transom horizontal.

16. The modular door frame of claim 13 wherein the hook comprises a first contact region that contacts an inner surface of the channel in the base transom horizontal, and a protrusion that contacts a front face of the base transom horizontal.

17. The modular door frame of claim 16 wherein the hook further comprises a second contact region that contacts a front face of the base transom horizontal, wherein the protrusion and second contact region contact the front face of the base transom at vertically distinct locations.

18. The modular door frame of claim 13 wherein the hook and channel maintain the sliding door track in a generally vertical alignment relative to the base transom horizontal.

19. The modular door frame of claim 13 wherein the sliding door track does not vertically extend above or below the base transom horizontal.

20. The modular door frame of claim 13 wherein the sliding door track further comprises:
an elongated channel member comprising a ridge; and
a cover configured to selectively couple to the sliding door track;
wherein the ridge is configured to enable the sliding door to be slidable.
